(19) United States
(12) Patent Application Publication
(10) Pub. No.: US 2009/0018876 A1
(43) Pub. Date: Jan. 15, 2009

(54) Rating system and method for rating an aquatic operation

(76) Inventor: Alvaro G. Mendoza, Jupiter, FL (US)

Correspondence Address: MCHALE & SLAVIN, P.A., 2855 PGA BLVD, PALM BEACH GARDENS, FL, 33410, US

(21) Appl. No.: 11/774,854

(22) Filed: Jul. 9, 2007

(51) Int. Cl. G06Q 10/00; G06F 17/40

(52) U.S. Cl. 705/7

(57) ABSTRACT

A swimming pool or aquatic facility rating method and system to rate a commercial pool or an organization's aquatic operation. The rating system and method is a based on a numerical star system that provides the operators and their patrons with a symbolic representation pertaining to the quality of the facility and its operation. The outcome of this rating method and system is a score which can vary form one to five stars. It is beneficial to both the owners of these facilities and their current and prospective customers to have a quantifiable system that is objective, reliable and easily understood.

### FIELD OF THE INVENTION

This disclosure generally relates to a rating method and system to rate a commercial pool or an organization's aquatic operation and more particularly to a rating method and system predicated on a star system that provides the operators and their patrons with a symbolic representation pertaining to the quality of the facility and its operation.

### BACKGROUND OF THE INVENTION

It is important to those in the hospitality industry to build and operate a swimming facility that provides its users with a safe and aesthetically pleasing environment. While appearances are somewhat readily apparent, other aspects of a swimming facility, such as construction and operation are not readily apparent to those unfamiliar with the intricacies of pool construction and operation. While pools can provide endless hours of enjoyment for their patrons they can also pose the possibility of hidden dangers if the pools are not constructed properly or operated safely. It is therefore of great benefit to both the owners of these facilities and their current and prospective customers to have a quantifiable system to quickly and easily ascertain the quality and safety of the swimming facility.

While in some instances around the country, county and state health department agencies will inspect and evaluate a swimming pool, spa or water feature on some limited standards pertaining to water quality; such limited evaluation is not sufficient, exhaustive or comprehensive enough to give an accurate representation of the facility's operation. The various Department of Health programs for water quality vary from state to state, with some states having no local programs at all. In those states without local governmental inspection, the operators and their patrons are relying solely and the knowledge, skills and abilities of their employees and/or contractors to ensure safe operation. The Florida Department of Health is recognized as one of the most advanced if not one of the strictest codes in the United States, yet it is not nearly as comprehensive in scope as the present rating system.

A star rating system is often used a symbolic protocol for ranking and classification purposes. They are commonly used in reviewing and ranking restaurants, hotels, cruise ships, movies, internet retailers and so forth. The restaurant ranking system was introduced by the Michelin Red Guide. The Michelin system gives its highest rating of three stars for the truly exceptional restaurant with the majority of restaurants receiving no star at all. There are also other guides which use from one to five stars, with one being the lowest rating. Other symbols such as forks, spoons or smiles have been used. Some restaurant reviews give separate rankings for food, service, ambience and noise. The star classification is often used for ranking hotels. Higher star rankings are indicative of higher levels of luxury. The Automobile Club of America (AAA) uses diamonds in lieu of stars to depict the facilities ranking. The Mobil Travel Guide provides the traveler with a listing of restaurants and accommodations around the country. A brief description is provided for each establishment. Based upon written establishment inspection reports the Guide management determines eligibility for listing within the guide. Ratings are then assigned to each establishment. Ratings are assigned as follows: 5 stars—One of the best in the country, 4 stars—Outstanding-worth as special trip; 3 stars—well appointed establishment, with full services and amenities; 2 stars—comfortable establishment with expanded services and amenities and 1 star—clean, convenient establishment with limited services. Ratings are based on formal and incognito inspection reports, letters, media reviews, etc. The Mobil Travel Guide's goal is to be a consumer advocacy group on travel. The rating system of the present invention is unique in that it is designed to address a need in the within the pool industry. At present there is no rating system available that addresses the full range of criteria encompassed by the present rating system.

### DESCRIPTION OF THE PRIOR ART

The following is an example of a water quality rating system. The water quality Star rating of the Australian Water Association consists of a six star rating system. Water with a zero star rating is wastewater which contains domestic sewage and trade waste. A one star rating is wastewater which has been screened to remove large solid matter. A two star rating is effluent which has its organic matter reduced and has been disinfected. A three star rating is effluent which has most of the organic matter removed, its nutrient content reduced and has been disinfected. A four star rating is reclaimed water which has received further treatment such as conventional or membrane filtration or other advanced processes. It is suitable for certain uses in industry and unrestricted irrigation on public areas or crops. A five star rating is water which ahs been treated sufficiently for human consumption. A six star rating is water suitable for kidney dialysis and pharmaceutical processes.

The following patents are directed to rating systems and methods. The patent to Torma et al, U.S. Pat. No. 5,365,425, discloses a system to measure the effectiveness of care at medical facilities. Measurements are taken of actual quality, cost and access performance characteristics of the medical facilities. The results of these measurements are plotted on a graph and deficiencies are identified. The patent to Fethe, U.S. Pat. No. 5,926,794, discloses an individual performance appraisal system. The system utilizes visual images to enable the raters to make comparisons. These images are then captured and turned into data for the supervisors and employees. The patent to Dirksen et al, U.S. Pat. No. 6,853,975, discloses a method for rating employee performance. Input is obtained from a manager of the employee, the employee's peers and the employee's direct reports. U.S. Published Patent Application No. 2001/0037233, to Kinoshita, is directed to a corporate rating system in which a corporate business entity, an entity desiring its own corporate rating and an application service provider are electronically connected to enable the exchange of information such as financial, accounting and tax information. The corporate rating business entity utilizes its own proprietary software to perform the corporate rating. U.S. Published Patent Application No. 2004/02336734 discloses a rating system and method of identifying desirable customers. Asset levels, demographic information and transaction history of the customer are compiled to obtain a prediction index. This index is used to determine if the customer is desirable.

### SUMMARY OF THE INVENTION

In view of the foregoing shortcomings concerning the evaluation and rating of pools or aquatic operations, it should be apparent that there exists an urgent need for an accurate, objective, reliable and credible rating system for designing, constructing, maintaining and operating commercial pools and aquatic operations.

Accordingly, it is a primary objective of the instant invention to provide a comprehensive and objective rating system for pools or aquatic operations.

It is a further objective of the instant invention to provide the pool industry with an understanding of the integral components required to maintain maximum water quality, and will assist them in attaining the next level of performance and results.

It is yet another objective of the instant invention to provide a rating system that goes beyond the rated minimum standards, and extends the performance criteria to allow a facility to offer the finest water quality even under the heaviest of bather loads. The system also offers the customer a path for improvement of operations through addition of equipment, procedural enhancements, operator training and certifications. The improvement path can be quantified, planned and budgeted. Direct and achievable improvements can be scheduled and procured based on the quality standards.

It is a still further objective of the invention to provide a proprietary interactive internet-based score sheet program that allows operators to track the effect of their property improvements in between their audited inspections.

Other objects and advantages of this invention will become apparent from the following description taken in conjunction with any accompanying drawings wherein are set forth, by way of illustration and example, certain embodiments of this invention. Any drawings contained herein constitute a part of this specification and include exemplary embodiments of the present invention and illustrate various objects and features thereof.

### BRIEF DESCRIPTION OF THE FIGURES

FIG. 1 is a perspective view of the computer system of the present invention.

FIGS. 2A and 2B are exemplary representations of the graphic user interface used to input data into the rating system.

FIG. 3 is a representation of the certification received by the owner/operator of the pool or aquatic facility as a result of the facility analysis, evaluation based on rating criteria, and computation of the input and subsequent result.

FIG. 4 is an installation diagram of an advanced pool system.

### DETAILED DESCRIPTION OF THE INVENTION

The details contained within the following description are used for purposes of illustration. Many specific details have been provided so as to provide a complete and thorough understanding of the present disclosure. It will be apparent to one skilled in the art that the present method and system may be practiced without these specific details. As such, the following descriptions are directed to an exemplary rating system and method for pools and aquatic facilities.

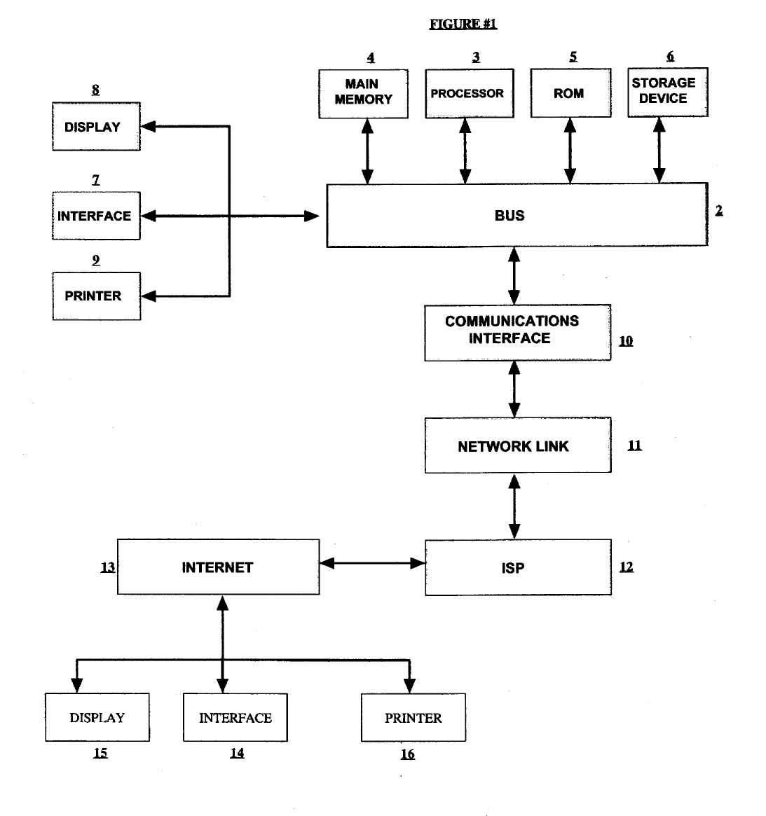

FIG. 1 is a schematic block diagram of an exemplary pool rating and system 1 of the present invention. The data processing system 1 includes a computer which is used to calculate a star rating for swimming pools and aquatic facilities based on a comprehensive set of criteria which will be discussed below in more detail. The star rating which can range from one star to a maximum of five stars gives a clear objective and accurate assessment as to construction, operation and maintenance of the swimming pool or facility. The data collected is compared to a bench mark established for each criteria which is considered to be relevant to the ultimate rating of the system. The data can be collected by an inspector or system auditor. In addition or alternatively, the data can be entered interactively between the facility and computer a system or inputted into the system by the user. The system has the capacity to store and or archive the data for future reference.

The inspector/auditor, user, and/or automated data input provides a score based on achievement of established goals and expectancies. The total values for each rating element is totaled and compared to a look up table or its equivalent and a star rating from one to five is assigned.

The following is an example of categories of interest, rating elements; scoring and subsequent ranking that can be used in the instant invention. The criteria can be broken down into five categories for evaluation. The five categories are; Safety and Code Compliance, Mechanical Systems, Pool and Spa Physical and Aesthetic Appeal, Oxidation and Water Quality and Operational Items. Each category contains ten rating elements and each element is assigned one point if it meets or exceeds the criteria and no points if it does not meet the criteria. The star rating is based on the attainment of the following scores out of a total of 50 possible points. A score of 10 points or less is given a one star rating. A score of 11-20 points results in a two star rating. The achievement of a score of 21-32 points would result in a three star rating. A four star rating would require a score between 33 and 44 points. The optimum rating, a five star rating, would require a score of 45 to 50 total points. The program would use a certified auditor and each pool would be surveyed at a minimum of once a year, but could be additionally inspected upon request at any time during the year.

As mentioned above, each category contains 10 rating elements. The category of safety and code compliance includes: 1) adherence to Department of Health circulation rate requirement (based on the local agency, but if none Florida standards will apply), 2) adherence to Department of Health bather load (based on the applicable Department of Health or Florida standard whichever is stricter), 3) properly certified pool operator on weekday staff, 4) properly certified pool operator on backup/weekend staff, 5) no active direct suction from pool, 6) automatic chemical feeder for ph and chlorine in place, 7) all deck equipment to department of health code (signs, hooks, life rings, etc.), 8) tiled, non slip depth markers and no-diving markers in place, 9) pool to ADA compliance with ADA approved lift and 10) pool use is made inaccessible during use of an insulated pool cover system. Some of these rating elements are considered to be potentially interactive variables, while others are user input variables that can be verified via a lookup table, or via research, while still others are certification variables that can be physically verified by an auditor or certified by the customer.

The category for Mechanical Systems includes: 1) chemical system safety interlocked to main circulation pump, 2) instrumentation package in place (pressure, vacuum and flow rate gauges—properly sized/liquid filled/stainless steel construction), 3) self priming pump used in above grade installations, 4) auto fill system operative and accurately holding continuous skimming level, 5) surge tank system sized to 15 gal/rated bather, or equipped with modulating float valve, 6) filtration system capable of backwashing automatically on preset levels, 7) automatic effluent turbidity monitoring and polymer feed, 8) automatic vacuum system in place (used when pool is not available to patrons), 9) redundant or backup of circulation system in house (preferably installed) and 10) non-metallic pool piping intact with absence of known in ground or pump room leaks. Some of these rating elements are user input variables that can be verified via a lookup table, or via research, while still others are certification variables that can be physically verified by an auditor or certified by the customer.

The third category, pool and spa physical and aesthetic appeal, includes the following rating elements; 1) deck appealing, slip resistant, with absence of cracks and depressions, 2) tile and coping appealing, uniform, intact, and without sharp edges, 3) absence of staining on pool surfaces or deck, 4) absence of pitting, cracking or degradation in pool finish or grout, 5) pool gutter level around entire perimeter, 6) absence of water line tile soiling or oily surface slick, 7) absence of surface or rooted algae, 8) pump room clean, dry, well ventilated, and with absence of irritants and fumes, 9) pump room piping color-coded and all valves and gauges identified and tagged and, 10) rest rooms conveniently located, clean, dry, well stocked, and well maintained. These rating elements are certification variables that can be physically verified by an auditor or certified by the customer.

The fourth category of oxidation and water quality contains the following rating elements: 1) ORP automatically maintained to 700+mv, 2) pH automatically maintained (7.2 to 7.6), 3) water clarity (clearly visible coin at 6 foot depth), 4) chlorinator capable to 6 ppm to turnover rate, 5) chlorinator capable to 12 ppm to turnover rate, 6) pH feeder sized to minimum of 50% of chlorinator sizing, 7) high strength supplemental oxidation systems in place, 8) calcium hardness maintained to acceptable levels (350-1,000 ppm), 9) total alkalinity to acceptable levels (60-140 ppm) and, 10) stabilizer to acceptable levels (0-30 ppm). Some of these rating elements are considered to be potentially interactive variables, while others are user input variables that can be verified via a lookup table, or via research, while still others are certification variables that can be physically verified by an auditor or certified by the customer.

The fifth category addresses operational items that includes the following rating elements; 1) chlorine and pH manually tested, compared to control system, and calibrated if needed, 2) chlorine and pH tested via digital photometer, 3) combined chlorine monitored and pool super chlorinated when levels exceed 0.4 ppm, 4) CSI water balance parameters monitored and corrected weekly, and held to acceptable (−0.3 to +0.3 level, 5) Ryznar index maintained with acceptable (6.3 to 6.7) level, 6) water quality logs sheets professionally maintained daily, and reviewed on a periodic basis, 7) PM programs in place for all mechanical equipment in equipment room and deck, 8) maintenance logs kept on all mechanical items including data and service information, 9) filter and strainer cleaning performed regularly, logged in, and based on gauge and flow readings, and, 10) comprehensive in-house program for code compliance, proper water quality, and overall pool operations. Some of these rating elements are user input variables that can be verified via a lookup table, or via research, while still others are certification variables that can be physically verified by an auditor or certified by the customer.

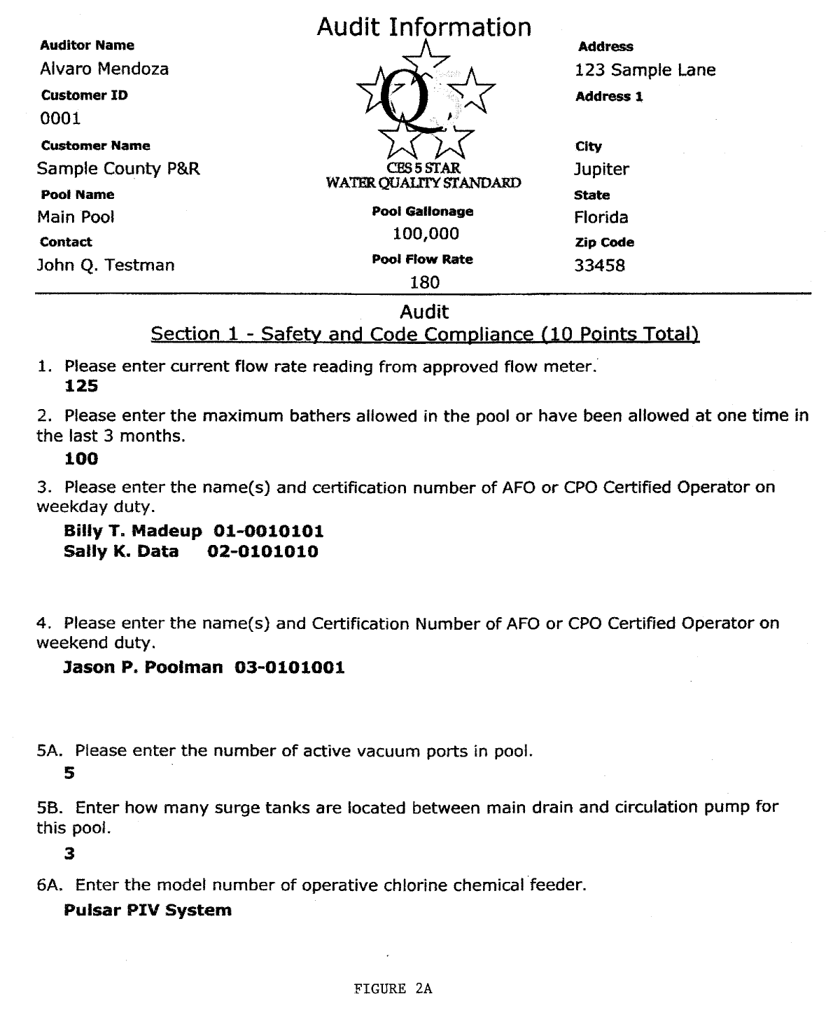

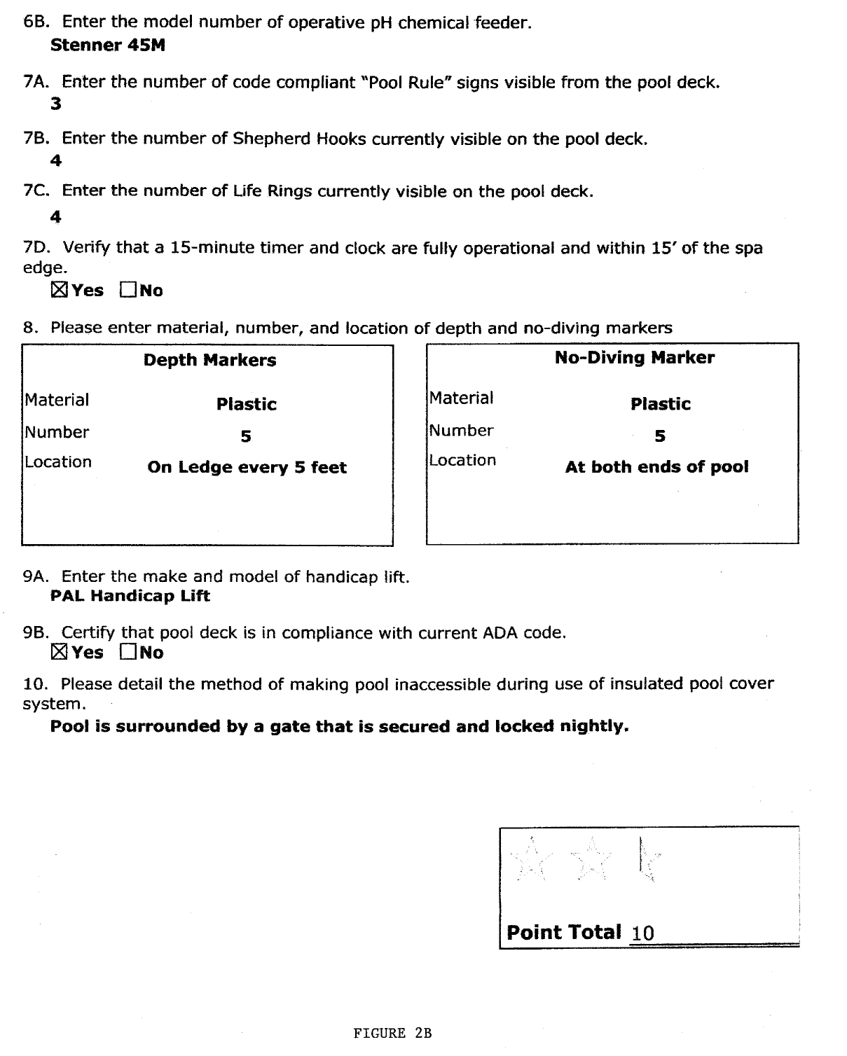

FIGS. 2A and 2B are examples of a graphic user interface that would enable the pool operator, auditor or inspector to enter the data into the computer. The program would require the user to respond to each and every rating element and would provide a running total of points achieved.

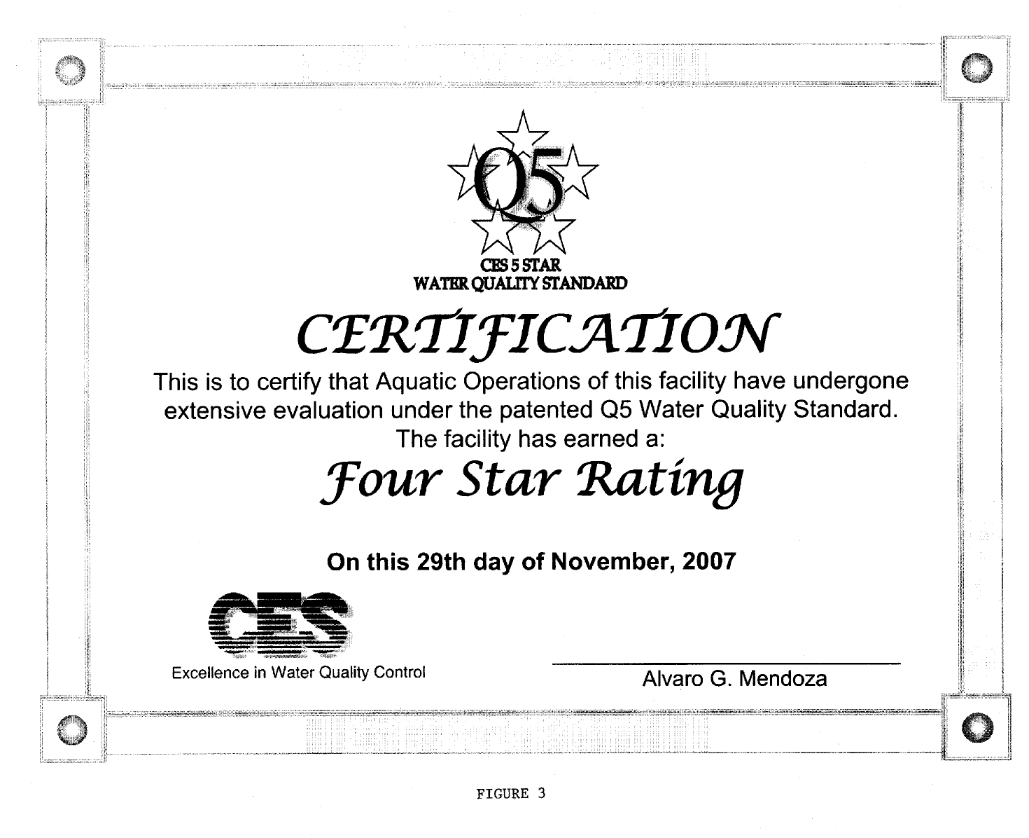

FIG. 3 is an example of a rating certificate that the owner/operator would receive following an audited inspection of the facilities. The certificate would be suitable for framing and would be displayed in a prominent location of the grounds so that users would also be made aware of the facilities overall quality.

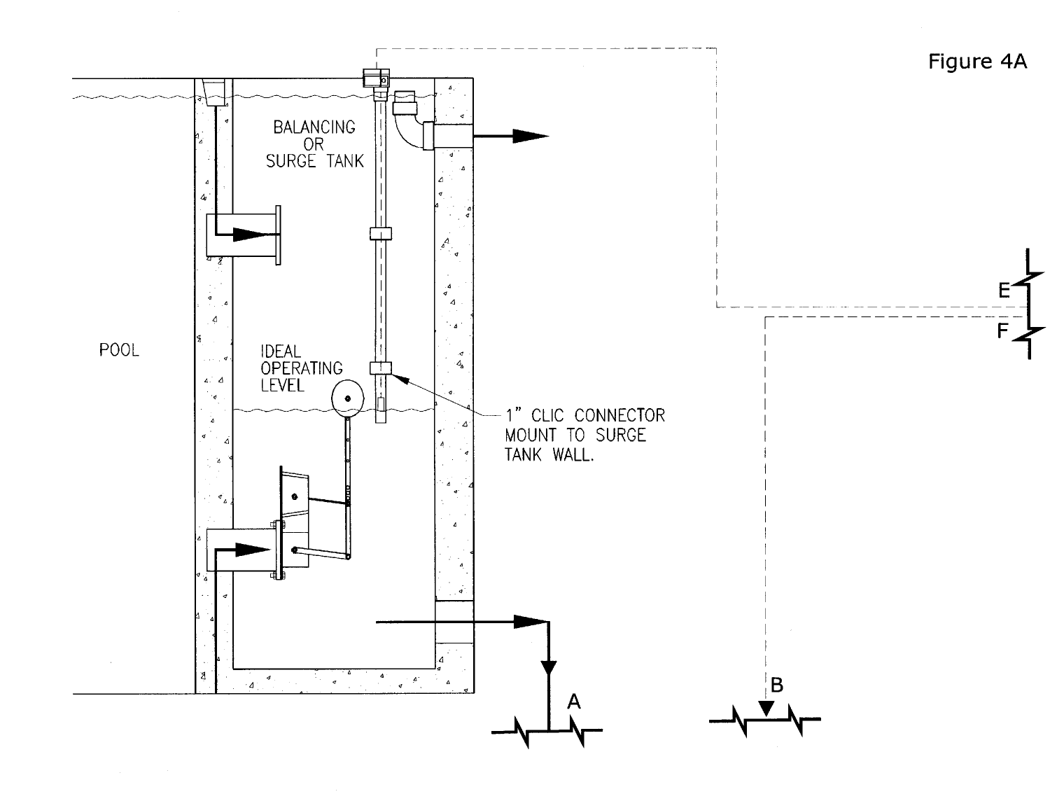

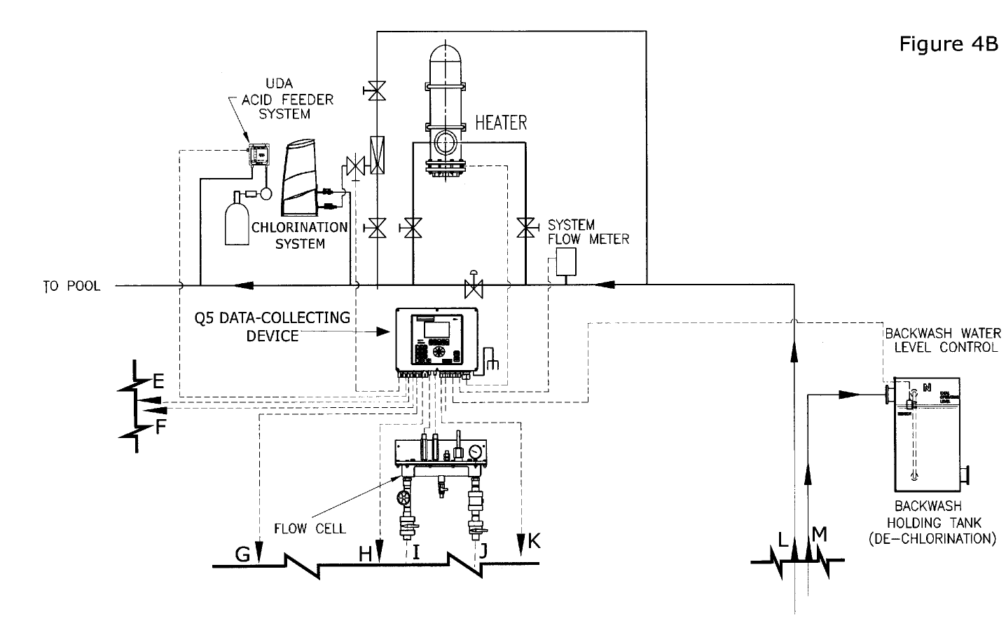

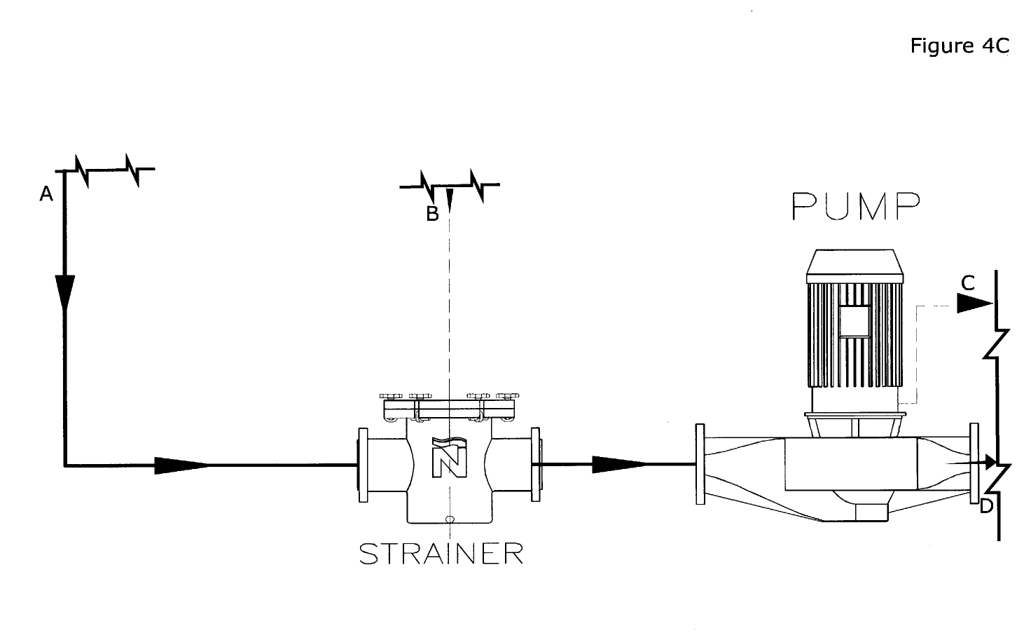

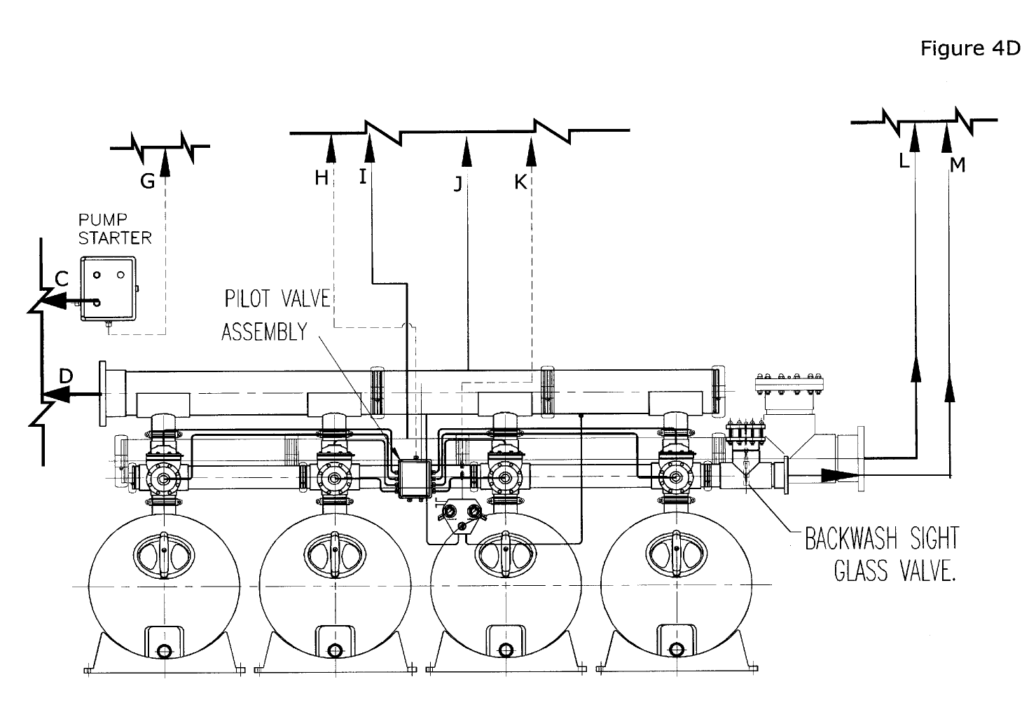

FIG. 4 is an installation diagram of an advanced pool system wherein the variables are constantly monitored, controlled and documented by on-site control equipment.

FIG. 1 illustrates a block diagram of the data processing system 1 which is used to perform the pool rating system. Data processing system 1 includes a bus 2 for communicating information. Connected to the bus 2 is a processor 3 for processing information, a main memory 4, a read only memory (ROM) 5 and a dynamic storage device 6. The main memory 4 (ram or its equivalent) is used for storing information and instructions from the processor 3 as well as storing temporary variables or other intermediate information. Static information and instructions for the processor is stored on ROM 5 or its equivalent. Dynamic storage device 6 can be a magnetic or optical disk and is used to storing information and providing instructions to the processor.

A user interface 7 is coupled to bus 2 for communicating information and commands to the processor 3. The interface 7 would include an alpha numeric key board, a mouse or a touch pad or its equivalent. Likewise, a video display 8 such as a cathode ray tube (CRT), a liquid crystal display or plasma screen would be connected to the bus to display information to the operator. A printer 9 is connected to bus 2, interface 7 and display 8.

The processing system 1 is controlled by the processor 3 executing one or more instructions contained in the main memory 4. These instructions are placed into the main memory 4 via a machine readable medium which can, for example, be read from the storage device 6.

The data processing system also includes a communications interface 10 connected to bus 2. The communications interface provides two way data communication to a network link 11. The interface may be an integrated services digital network (ISDN), a telephone modem, or a wired or wireless local area network (LAN). The network link connects the system to the internet via an internet service provider 12. The data system can then send and receive data over the internet to other user stations which include an interface device 15, a display 15, and a printer 16, remote from the main computer system. The communications capabilities of the system allow the loading of relevant data into the system from remote locations for calculating the rating of a particular swimming pool. In addition, it allows the user/operator to receive compiled results and system ratings directly over the internet.

A personal computer (PC) is only one type of data processing equipment that may be used to implement the pool rating system. Other devices such as personal digital assistants (PDAs), web based televisions and cellular and land line telephones may also be used.

The system and method for rating a pool can be implemented utilizing just a single personal computer. Alternatively, in could be designed to handle a plurality of PCs and other types of data processing equipment that are either co-located or, using the internet, distributed over an infinite number of geographic locations.

All patents and publications mentioned in this specification are indicative of the levels of those skilled in the art to which the invention pertains. All patents and publications are herein incorporated by reference to the same extent as if each individual publication was specifically and individually indicated to be incorporated by reference.

It is to be understood that while a certain form of the invention is illustrated, it is not to be limited to the specific form or arrangement herein described and shown. It will be apparent to those skilled in the art that various changes may be made without departing from the scope of the invention and the invention is not to be considered limited to what is shown and described in the specification and any drawings/figures included herein.

One skilled in the art will readily appreciate that the present invention is well adapted to carry out the objectives and obtain the ends and advantages mentioned, as well as those inherent therein. The embodiments, methods, procedures and techniques described herein are presently representative of the preferred embodiments, are intended to be exemplary and are not intended as limitations on the scope. Changes therein and other uses will occur to those skilled in the art which are encompassed within the spirit of the invention and are defined by the scope of the appended claims. Although the invention has been described in connection with specific preferred embodiments, it should be understood that the invention as claimed should not be unduly limited to such specific embodiments. Indeed, various modifications of the described modes for carrying out the invention which are obvious to those skilled in the art are intended to be within the scope of the following claims.

1. A swimming pool rating method comprising the steps of:
establishing a set of rating elements,
inspecting and evaluating a swimming pool against said set of rating elements,
determining a score for each of said rating elements,
inputting said score for each rating element into a data processing system,
calculating a total score based on a summation of scores for all of said rating elements,
establishing a standard ranking system based on the amount of total points scored,
comparing the value of total points scored to a previously established value within said rating system,
wherein the data processing system establishes a ranking for said swimming pool based a comparison of the total points scored to said previously established value.

2. A swimming pool rating method of claim 1, wherein the step of establishing the set of rating elements is organized into five separate categories.

3. A swimming pool rating method of claim 2, wherein the five categories include; safety and code compliance, mechanical systems, physical and aesthetic appeal, oxidation and water quality and operational items.

4. A swimming pool rating method of claim 1, wherein the score for said rating element is entered into said data processing system automatically by an interactive device.

5. A swimming pool rating method of claim 1, wherein the score for said rating element is entered into said data processing system by a pool operator.

6. A swimming pool rating method of claim 1, wherein the score for each rating element is based upon a physical inspection by a rating system auditor or certified by the pool operator and entered into said data processing system.

7. A swimming pool rating method of claim 1, wherein the score for each rating element is entered into the data system by a pool operator or a rating system auditor using an interactive device and a video display connected to said data processing system and said video display contains a graphic user interface to facilitate input of said scores into said data processing system.

8. A swimming pool rating method of claim 7, wherein the data is entered into the data processing system from a remote location through an internet connection.

9. A swimming pool rating method of claim 1, wherein the ranking system includes a designation of one to five stars with one star being the lowest rating and five stars being the highest rating.

10. A swimming pool rating method of claim 7, wherein the data is received by said interactive device and video display from the data processing system located in a remote location through an internet connection.

11. A swimming pool rating system comprising:
a data processing system which includes a processor for processing data;
a data storage device coupled to the processor;
the data storage device bearing instructions to cause the data system to produce a pool ranking by performing the steps of:
establishing a set of rating elements,
inspecting and evaluating a swimming pool against said set of rating elements,
determining a score for each of said rating elements,
inputting said score for each rating element into a data processing system,
calculating a total score based on a summation of scores for all of said rating elements,
establishing a standard ranking system based on the amount of total points scored,
comparing the value of total points scored to a previously established value within said rating system,
wherein the data processing system establishes a ranking for said swimming pool based a comparison of the total points scored to said previously established value.

12. A swimming pool rating system of claim 11, wherein the set of rating elements is organized into five separate categories.

13. A swimming pool rating system of claim 12, wherein the five categories include; safety and code compliance, mechanical systems, physical and aesthetic appeal, oxidation and water quality and operational items.

14. A swimming pool rating system of claim 12, wherein the score for said rating element is entered into said data processing system automatically by an interactive device.

15. A swimming pool rating system of claim 11, wherein the score for said rating element is entered into said data processing system by a pool operator.

16. A swimming pool rating system of claim 11, wherein the score for each rating element is based upon a physical inspection by a rating system auditor or certified by the pool operator and entered into said data processing system.

17. A swimming pool rating system of claim 11, wherein the score for each rating element is entered into the data system by a pool operator or a rating system auditor using an interactive device and a video display connected to said data processing system and said video display contains a graphic user interface to facilitate input of said scores into said data processing system.

18. A swimming pool rating system of claim 17, wherein the data is entered into the data processing system from a remote location through an internet connection.

19. A swimming pool rating system of claim 11, wherein the ranking system includes a designation of one to five stars with one star being the lowest rating and five stars being the highest rating.

20. A swimming pool rating system of claim 17, wherein the data is received by said interactive device and video display from the data processing system located in a remote location through an internet connection.
